(19) United States
(12) Patent Application Publication
(10) Pub. No.: US 2013/0002480 A1
(43) Pub. Date: Jan. 3, 2013

(54) Reference Satellite

(75) Inventors: Anthony Richard Pratt, Northamptonshire (GB); Murray Robert Jarvis, Stapleford (GB)

(73) Assignee: CAMBRIDGE SILICON RADIO LIMITED, Cambridge (GB)

(21) Appl. No.: 13/344,410

(22) Filed: Jan. 5, 2012

(30) Foreign Application Priority Data
Jan. 5, 2011 (GB) 1100116.1

(51) Int. Cl. G01S 19/42

(52) U.S. Cl. 342/357.25

(57) ABSTRACT

An apparatus for determining the location of a receiver in dependence on signalling events transmitted to the receiver by a satellite constellation comprising a reference satellite and one or more other satellites, the apparatus being arranged to, for each of the one or more satellites, compare an indication of the transit time of the signalling event transmitted by that satellite and an indication of the transit time of the signalling event transmitted by the reference satellite and calculate the location of the receiver in dependence on those comparisons; the apparatus being further arranged to determine, for each of the satellites in the constellation, an indication of an error that would be incorporated in the comparisons if that satellite were selected as the reference satellite and to designate one of the satellites in the constellation as the reference satellite in dependence on those indications.

### BACKGROUND OF THE INVENTION

The invention relates to an apparatus and a method for selecting a reference satellite for use in a Global Navigation Satellite System (GNSS) location calculation.

The Global Positioning System (GPS) is an example of a GNSS navigation system in which a receiver determines its position by precisely measuring the arrival time of signalling events received from multiple satellites. Each satellite transmits a navigation message containing the precise time when the message was transmitted and ephemeris information. Each sub-frame of the navigation message starts with a telemetry word (TLM) and the number of the sub-frame. The start of the sub-frame may be detected by means of a preamble sequence in the TLM. Each sub-frame also includes a handover word (HOW), which gives the exact time of the week (TOW) when the satellite will transmit the next sub-frame according to the local version of GPS time held by the satellite's clock. The ephemeris information includes details about the satellite's orbit and corrections for the satellite's own clock, in comparison with GPS time. The ephemeris and clock correction parameters may collectively be known as ephemeris information.

GPS signals are formed of a navigation message binary phase shift modulated (BPSK) onto a direct sequence spread spectrum signal. The spread spectrum signal comprises a unique pseudo-noise (PN) code that identifies the satellite. For civil application GPS signals transmitted using the L1 frequency, this code is known as the C/A code. The C/A code has a sequence length of 1023 chips and it is spread with a 1.023 MHz chipping rate. The code sequence therefore repeats every millisecond. The code sequence has an identified start instant when the two code generators in the satellite just transition to the all ‘1s’ state. This instant is known as the code epoch. After various transport delays in the satellite, the code epoch is broadcast. This signalling event can be recognised, in suitably adapted receivers, through a process of aligning a replica code with the code received from each satellite.

The navigation message has a lower data rate of 50 bits per second and its start is synchronised with the start of the C/A code sequence. Each bit of the navigation message lasts for 20 milliseconds and thus incorporates 20 repetitions of the C/A code. The navigation message is constructed from a 1500-bit frame consisting of five 300-bit sub-frames. Each sub-frame lasts for 6 seconds. The satellite transmits the navigation message and C/A code using a carrier frequency that is an integer multiple of 10.23 MHz (for the L1 carrier, the multiple is 154).

In addition to the time and ephemeris information, the data message also contains the satellite constellation almanac, parameters representing the ionospheric and tropospheric delay, health parameters and other information used by some receivers. There are 25 different frames of data broadcast from each satellite. Each frame contains identical information (apart from time) in sub-frames 1-3 inclusive but cycles through a pre-assigned sequence of data in sub-frames 4 and 5, which contain almanac and other information.

As mentioned above, a GPS receiver may determine the time-of-arrival of a signalling event through a process of aligning a replica code with the code received from each satellite. The receiver may also use the TOW information contained in the navigation message to determine the time when the signalling event was transmitted. From this, the receiver can determine the transit time for the signalling event (from which it can determine the distance between it and the satellite), together with the position of the satellite at the time when the signalling event was transmitted (using the ephemeris information). The receiver can then calculate its own position. Theoretically, the position of the GPS receiver can be determined using signals from three satellites, providing the receiver has a precise time or knowledge of part of the positions, such as altitude. However, in practice GPS receivers use signals from four or more satellites to determine an accurate three-dimensional location solution because an offset between the receiver clock and GPS time introduces an additional unknown into the calculation.

If the satellite signal reception is poor (commonly known as weak signal conditions), or if the receiver only receives a short burst of the signal, the receiver may not be able to decode the TOW information. Without this information, the GPS receiver may be unable to determine the distance between it and the satellite with sufficient accuracy because the receiver will not know the time when the signalling event was transmitted. Under weak signal conditions or briefly glimpsed signals, the receiver may also be unable to recognise the start of a sub-frame since it may not be able to decode the TLM.

A receiver that has been unable to decode the TLM and TOW information in the navigation message may nonetheless be able to deduce some timing information even under weak signal conditions or from briefly-glimpsed signals. For example, the receiver may be able to determine a time shift between the satellite signal's spreading (PN) code and a locally generated version of the same, e.g. by correlating the received signal with a locally generated replica of the PN code or by using an equivalent signal processing technique. This time shift represents at least part of the transit time for the satellite signal. However, since both the PN code in the signal and the locally generated replica code are of finite length in space (known as the code wavelength), the correlation operation can only identify a part of the total time shift. This part of the total time shift represents only the fractional part of the signal transit time between satellite and user. This leaves unknown the integer number of code repetition intervals the signal took to travel between the satellite and the receiver.

In order to compute its position accurately, the receiver also needs to be able to resolve discrepancies between the various clocks in the system. GPS time is defined by an ensemble of clocks generally located at the US Naval Observatory in Washington. Each satellite has its own operating clock (usually one of three on board the space vehicle), which is approximately synchronised with GPS time. In practice, however, the satellite clock is biased from GPS time by a small amount. The receiver clock is also likely to be biased from GPS time, at least prior to an initial location solution. Uncorrected, these clock biases introduce significant errors into the location calculation.

Various algorithms have been proposed to enable the location of a receiver to be calculated under weak signal conditions or when the satellite signals are only briefly glimpsed by the receiver. These algorithms address the unknown integer number of code repetition intervals and unknown receiver clock bias in a multitude of different ways. However, they all typically introduce the time-of-transmission of the signal as an additional unknown in the location calculation. Signalling events may, therefore, be required from five or more satellites in order to solve for the additional unknown. They also all typically involve an initial step of estimating the location of the receiver and the time-of-transmission of the signalling events. A common feature of many of the algorithms is the designation of one of the satellites, visible to the receiver, as a reference satellite. These algorithms typically use the reference satellite as a base against which all other satellites are compared. Some examples are described below.

FIG. 1 shows a GPS receiver 101 receiving GPS signals 107a and 107b from two GPS satellites, 103 and 104. Each satellite is travelling according to a respective orbit (105 and 106). The GPS receiver may designate one of these satellites as a reference satellite. This satellite sets the time base against which all other signals are measured.

First consider the case of a signal received from single satellite 104. The time-of-arrival of signalling event 107b at GPS receiver 101 can be expressed as:

$${t}_{rx , j} = {t}_{sat , j} + \frac{{D}_{j} ( {t}_{sat , j} )}{c} + \frac{( {B}_{U} - {B}_{SV , j} )}{c} + \frac{( {d}_{iono , j} + {d}_{tropo , j} )}{c} + {ɛ}_{j} \qquad ( 1 )$$

where:

t_{rx,j} is the arrival time of the signalling event transmitted by satellite j at the receiver (which in this instance is the full time-of-arrival rather than just the fractional part; ambiguity in the measured time-of-arrival and how it may be resolved are discussed later);
t_{sat,j} is the time when the signalling event was transmitted;
Dⱼ(t_{sat,j}) is the distance between the receiver and satellite j;
B_{U} is the receiver clock bias, expressed in terms of distance;
B_{SV,j} is the clock bias of satellite j, expressed in terms of distance;
d_{iono,j} and d_{tropo,j} are the excess delays due to signal transition through the ionosphere and troposphere, over those in free space, expressed in terms of distance;
εⱼ is the measurement error, which is mainly due to noise and multipath errors; and
c is the speed of light in metres per second.

Equation (1) can be extended by comparing signalling event 107b received from satellite 104 with signalling event 107a from reference satellite 103. Rather than consider each time-of-arrival independently, the receiver may measure only the difference between the arrival times. This eliminates the receiver clock bias, which is identical for both. The receiver clock bias is the difference between the time held in the receiver clock to an absolute or reference time, such as GPS time. If it is assumed that the transmitted events occurred at the same GPS time (as measured by each satellite), this gives the following equation:

$${t}_{rx , j} - {t}_{rx , 0} = \frac{{D}_{j} ( t ) - {D}_{0} ( t )}{c} + \frac{( {B}_{SV , 0} - {B}_{SV , j} )}{c} + \frac{( {d}_{iono , j} - {d}_{iono , 0} + {d}_{tropo , j} - {d}_{tropo , 0} )}{c} + ( {ɛ}_{i} - {ɛ}_{0} ) \qquad ( 2 )$$

where the reference satellite is designated by the subscript ‘0’ and t designates the absolute time corresponding to the signalling event transmitted by each satellite.

A problem with solving equation (2) is that under weak signal conditions the receiver may be unable to distinguish the arrival of repetitive events from each other. For example, a GPS receiver may be able to detect the start of each code epoch, even under weak signal conditions, but those code epochs repeat at 1 ms intervals. Without being able to decode more of the signal, therefore, the receiver is unable to directly identify which of the repetitive signalling events received from the j^{th} satellite and the reference satellite were transmitted at the same GPS time (as measured by each satellite). It is therefore unclear which times-of-arrival should be compared with each other in calculating t_{rx,j}−t_{rx,0}.

One option is to predict a likely time-of-arrival for a signalling event transmitted by the j^{th} satellite using the time-of-arrival of the corresponding signalling event from the reference satellite, estimated distances between the receiver and each of the satellites and the differences in the clock biases between the satellites.

The distance between the j^{th} satellite and the receiver may be defined as the Euclidean norm of the difference in vector positions, (x_{SV,j}−x), where x_{SV,j} is the position vector of the j^{th} satellite and x is the position vector of the receiver. The estimated distance between the j^{th} satellite and the receiver may be defined as the Euclidean norm of the difference in vector positions, (x_{SV,j}(tₑ)−xₑ), where x_{SV,j}(tₑ) is the position vector that corresponds to the location of the j^{th} satellite at an initial estimate of (GPS) time tₑ and xₑ is the position vector corresponding to an initial estimate of the location of the receiver. This gives rise to the following equations:

$${D}_{j} ( t ) = \sqrt{{( {x}_{SV , j} ( t ) - x )}^{2} + {( {y}_{SV , j} ( t ) - y )}^{2} + {( {z}_{SV , j} ( t ) - z )}^{2}} \\ {\hat{D}}_{j} ( {t}_{e} ) = \sqrt{{( {x}_{SV , j} ( {t}_{e} ) - {x}_{0} )}^{2} + {( {y}_{SV , j} ( {t}_{e} ) - {y}_{0} )}^{2} + {( {z}_{SV , j} ( {t}_{e} ) - {z}_{0} )}^{2}} \qquad ( 3 )$$

Once a time-of-arrival for the signal has been predicted, the actual time-of-arrival of a signalling event from the j^{th} satellite that is closest to that predicted time may be selected as the actual time-of-arrival. Subtracting the predicted time-of-arrival from the actual time-of-arrival gives a single difference residual, which can be converted into an equivalent range residual, through division by the speed of light, c. The single-difference range residual may be defined as follows:

∇r_{rx,j0}=∇R_{rx,j0}−(\hat{D}ⱼ(tₑ)−\hat{D}₀(tₑ)+∇Bⱼ₀ (4)

where:
∇r_{rx,j0} is the single difference residual in range, the error arising from errors in the original estimates of GPS time and GPS receiver position;
∇R_{rx,j0} is the difference in range between the reference satellite and satellite j as indicated by the times-of-arrival of the signals from those satellites;
\hat{D}ⱼ(tₑ) is the estimated distance between the GPS receiver and the reference satellite at the estimated GPS time, tₑ;
\hat{D}₀(tₑ) is the estimated distance between the GPS receiver and satellite j at the estimated GPS time, tₑ; and
∇Bⱼ₀ is the (single) difference in the clock biases of the reference satellite and satellite j expressed in terms of distance.

The expression for \hat{D}ⱼ(tₑ) can be substituted into equation (4) to give an expression for the single difference residual in terms of the initial estimates of receiver position and absolute time. Using a Taylor Series approximation, limited to the first two terms, and combining together the equations for each non-reference/reference satellite combination, equation (4) can be rewritten as:

$$\vert \begin{matrix}∇ {r}_{10} \\ ∇ {r}_{20} \\ ⋮ \\ ⋮ \\ ∇ {r}_{n 0}\end{matrix} \vert = \vert \begin{matrix}- ∇ cos ( {α}_{x 1}^{0} ) & - ∇ cos ( {α}_{y 1}^{0} ) & - ∇ cos ( {α}_{z 1}^{0} ) & ( {\dot{ρ}}_{1} - {\dot{ρ}}_{0} ) \\ - ∇ cos ( {α}_{x 2}^{0} ) & - ∇ cos ( {α}_{y 2}^{0} ) & - ∇ cos ( {α}_{z 2}^{0} ) & ( {\dot{ρ}}_{2} - {\dot{ρ}}_{0} ) \\ ⋮ & ⋮ & & \\ & ⋮ & & \\ - ∇ cos ( {α}_{xn}^{0} ) & - ∇ cos ( {α}_{yn}^{0} ) & - ∇ cos ( {α}_{z 2}^{0} ) & ( {\dot{ρ}}_{n} - {\dot{ρ}}_{0} )\end{matrix} \vert \cdot \vert \begin{matrix}Δ x \\ Δ y \\ Δ z \\ Δ t\end{matrix} \vert \qquad ( 5 )$$

Or, more compactly in matrix form, as:

∇r=∇H·∇X

where
∇rⱼ₀ are the single difference residuals for the j^{th} satellite and the reference satellite, expressed in terms of distance;
∇ cos(αₓⱼ⁰), ∇ cos(α_{yj}⁰) and ∇ cos(α_{zj}⁰) are the differences in the direction cosines for the j^{th} satellite and the reference satellite;
∇H is defined as the single difference observation matrix, which can be derived from the observation or geometry matrix;
\dot{ρ}ⱼ is the velocity of the j^{th} satellite resolved along the line-of-sight between the receiver and the j^{th} satellite; and
Δx, Δy, Δz and Δt are the errors in the originally estimated user position and GPS time.

The equation can be exactly solved with a minimum of four single difference measurements (using five satellites). There is a unique solution which provides corrections to (x, t):

Δx=∇H⁻¹·∇r (6)

The algorithm above was described on the basis that all signalling events were transmitted at the same absolute time (according to the satellites' clocks). A similar algorithm selects signalling events that were transmitted at different absolute times according to the satellites' clocks. The algorithm is essentially the same as that described above, except that the predicted time-of-arrival for the j^{th} satellite additionally incorporates compensation for the difference in transmission times between the signalling events transmitted by the reference satellite and the j^{th} satellite.

An example of how the single-difference method described above might be implemented in practice is described below. In this example, the location system is a GPS system and the receiver is only capable of decoding the C/A code in the received satellite signals. The signalling events detected by the receiver are thus code epochs, the time between repetitive signalling events is 1 ms and the receiver is able to determine times-of-arrival of the signalling events that are sub-one-millisecond. This is for the purposes of example only, as the algorithm described below is equally applicable to other satellite navigation systems and to scenarios in which the receiver is able to measure a greater or lesser portion of the transit time of the signalling event.

This example of the single-difference algorithm may be explained by first splitting the full time-of-arrival of equation (1) into its integer and fractional components on the left hand side, and using t_{gps} as the time of that the signalling event was transmitted from the satellite:

$${τ}_{j} + {N}_{j} = {t}_{gps} + \frac{{D}_{j} ( {t}_{gps} )}{c} + \frac{( {B}_{U} - {B}_{SV , j} )}{ c} + \frac{( {d}_{iono , j} + {d}_{tropo , j} )}{c} + {ɛ}_{j} \qquad ( 7 )$$

τⱼ the fractional, measured part of the time-of-arrival (sub-one-millisecond) and Nⱼ is the unobserved integer part of the time-of-arrival (an unknown integer number of milliseconds, more generally representing an unknown integer number of code repetition intervals).

Once again, the reference satellite can be used to set a time base against which all other satellites are compared. Taking the difference between equation 7 and a reference satellite yields the following equation, noting that the tilde over the τ terms signifies that these signalling event arrival times are corrected for the satellite clock bias:

$${\tilde{τ}}_{j} = {τ}_{j} + \frac{{B}_{SV , j}}{c} \\ ( {\tilde{τ}}_{j} - {\tilde{D}}_{j} ( {x}_{e} , {t}_{e} ) / c ) - ( {\tilde{τ}}_{0} - {\tilde{D}}_{0} ( {x}_{e} , {t}_{e} ) / c ) = - ( {N}_{j} - {N}_{0} ) + ( {\tilde{ɛ}}_{j} - {\tilde{ɛ}}_{0} ) \qquad ( 8 )$$

The residual ionospheric and tropospheric errors have been subsumed into the error terms, ε, in equation 8. All of the terms on the left-hand side of equation (8) are known or can be estimated. The right-hand side of equation (8) is close to an integer millisecond since the errors are small. A modulo operation can be performed on both sides of equation (8) to remove the integer millisecond component as an unknown:

|(\tilde{τ}ⱼ−\hat{D}ⱼ(tₑ)/c)−(\tilde{τ}₀−\hat{D}₀(tₑ)/c)|_{mod 1ms}=(\tilde{s}ⱼ−\tilde{s}₀) (9)

Equations 7 through 9 inclusive can be converted from time to distance through multiplication throughout by the speed of light, c. The term c·τⱼ represents the sub-code wavelength part of the distance between the receiver and the j^{th} satellite.

When equation (9) is evaluated with estimated distances, rather than the true distances, correct elimination of the integer term is achieved when (excepting a small region of error due to the effects of noise and multipath represented by c·(εⱼ−ε₀)):

|(Dⱼ−\hat{D}ⱼ(xₑ,tₑ))−(D₀−\hat{D}₀(xₑ,tₑ))|<0.5λ_{c} (10)

Equation 10 represents a re-organisation of equations 7 and 8 through the replacement of the signalling event transit time by the satellite to receiver distance, Dⱼ, D₀. In addition, xₑ and tₑ are the initial estimates of user position and GPS time respectively and λ_{c} is the distance between repetitive signalling events, which is approximately 300 km for GPS C/A code epochs.

The updates to the initial estimates of receiver location and absolute time may once again be computed by means of equation (6). In this version of the algorithm, the vector ∇r can be formed by first constructing a vector Δt. The vector Δt, in units of milliseconds appropriate for C/A code GPS signals, can be constructed as follows:

Δtⱼ=1000×[(\tilde{τ}ⱼ−\hat{D}ⱼ/c)−(\tilde{τ}₀−\hat{D}₀/c)] (11)

Assuming GPS satellites, and the signalling events identified by the receiver will be the start of a 1 ms C/A code, \tilde{τ}ⱼ are the measured, sub-ms portions of the times-of-arrival after correction for the satellite clock bias or biases. The integer part of equation (11) may be removed by performing a modulo 1 ms operation and the result converted into metres.

$$Δ {t}_{j} = mod ( Δ {t}_{j} , 1 ) \\ if ( Δ {t}_{j} > 0.5 ) \text{:} \\ Δ {t}_{j} = Δ {t}_{j} - 1 \\ Δ {r}_{j} = \frac{n}{1000} Δ {t}_{j} \qquad ( 12 )$$

Once vector Δrⱼ has been constructed equation (6) can be solved to compute the position and time updates.

For both algorithms described above, equation (6) may be straightforwardly solved using standard techniques—for example, equation (13) is used to solve for over-determined least squares systems with uniform weighting:

Δx−(∇H^{T}·∇H)⁻¹·∇H^{T}·∇r (13)

Designating one of the satellites as the reference satellite may provide two advantages in the algorithms described above: first, it addresses the issue of integer ambiguity in the measured times-of-arrival; and second, it removes the receiver clock bias as an unknown at the instant of measurement, as the arrival of each signalling event is measured with reference to the arrival of the signalling event from the reference satellite. In this way, the receiver clock bias does not contaminate the measurements and does not enter into the location calculations. The receiver clock is used, however, to provide a timescale for measuring the time differences between the arrival times of the various signalling events; for example, using the intervals between the ‘ticks’ of the receiver clock to measure time differences.

Another algorithm for calculating the location of a receiver under poor signal conditions or when the receiver has only briefly glimpsed the satellite signals is described in U.S. Pat. No. 6,417,801. The algorithm presented in U.S. Pat. No. 6,417,801 also involves designating one of the satellites as a reference satellite. The algorithm differs from those described above, however, in that the integer millisecond ambiguity is estimated directly. This estimation is achieved by estimating the distance between the receiver and the satellite and comparing this with a measured, sub-millisecond pseudo-range of a signal transmitted by that satellite. The integer ambiguities for the remaining satellites are then estimated using the estimated integer for the first satellite, i.e. the first satellite is treated as a reference satellite against which all other satellites are compared. This technique is also described in “A-GPS: Assisted GPS, GNSS and SBAS 72” by Frank Van Diggelen (see chapter 4).

The choice of the reference satellite impacts on the location algorithm's tolerance of errors in the a priori estimates of receiver position and absolute time. There is therefore a need for an improved procedure for selecting which of the available satellites is most suitable for being used as the reference satellite.

### SUMMARY OF THE INVENTION

According to a first embodiment of the invention, there is provided an apparatus for determining the location of a receiver in dependence on signalling events transmitted to the receiver by a satellite constellation comprising a reference satellite and one or more other satellites, the apparatus being arranged to, for each of the one or more satellites, compare an indication of the transit time of the signalling event transmitted by that satellite and an indication of the transit time of the signalling event transmitted by the reference satellite and calculate the location of the receiver in dependence on those comparisons, the apparatus being further arranged to determine, for each of the satellites in the constellation, an indication of an error that would be incorporated in the comparisons if that satellite were selected as the reference satellite and to designate one of the satellites in the constellation as the reference satellite in dependence on those indications.

The apparatus may be arranged to determine an estimated transmission time for the signalling events transmitted by each satellite and an estimated location of the receiver.

The apparatus may be arranged to compare the indications of the transit times in dependence on the estimated transmission time of the signalling event transmitted by the satellite, the estimated transmission time of the signalling event transmitted by the reference satellite and the estimated location of the receiver.

The apparatus may be arranged to determine an indication of the error that would be incorporated in the comparisons in dependence on an error comprised in the estimates of transmission time and/or the estimate of receiver location.

The apparatus may be arranged to use as the indication of the transit time of a signalling event a time-of-arrival of that signalling event at the receiver.

The apparatus may be arranged to use as the indication of the transit time of a signalling event an estimated distance between the receiver and the satellite that transmitted that signalling event.

The apparatus may be arranged to estimate the distance between the receiver and the satellite in dependence on the estimated time of transmission of the signalling event transmitted by that satellite and the estimated location of the receiver.

The apparatus may be arranged to determine an average line-of-sight velocity for the satellites in the constellation.

The apparatus may be arranged to designate, as the reference satellite, the satellite having a line-of-sight velocity that is closest to the average line-of-sight velocity.

The apparatus may be arranged to determine a direction vector corresponding to an average of the direction vectors from the receiver to each satellite in the constellation.

The apparatus may be arranged to designate, as the reference satellite, the satellite for which the direction vector from the receiver to that satellite is closest to the average direction vector.

The apparatus may be arranged to designate, as the reference satellite, the satellite in the constellation having either the closest line-of-sight velocity to the average line-of-sight velocity or the direction vector to the receiver that is closest to the average direction vector in dependence on the relative magnitudes of an error in the estimate of the location of the receiver and an error in the estimates of the transmission times.

The apparatus may be arranged to designate as the reference satellite the satellite of the plurality of satellites having an optimum combination of line-of-sight velocity and direction vector in relation to the average line-of-sight velocity and average direction vector.

The apparatus may be arranged to calculate for each of the plurality of satellites a metric, Δⱼ², that is given by the following equation:

$${Δ}_{j}^{2} = {[ \vert {R}_{MAX} \vert \underline{a} . ( \overline{n} - {n}_{j} ) ]}^{2} + {[ \vert {R}_{MAX} \vert \underline{b} . ( \overline{n} - {n}_{j} ) ]}^{2} + {[ \vert Δ {t}_{MAX} \vert \vert \frac{\partial \overline{ρ}}{\partial t} - \frac{\partial {ρ}_{j}}{\partial t} \vert ]}^{2}$$

in which:
n̅ is a mean of the unit vectors between the receiver and the plurality of satellites;
nⱼ is the unit vector between the receiver and the ‘j^{th}’ satellite;
R_{MAX} is a maximum error in an original estimate of the position of the GPS receiver;
Δt_{MAX} is a maximum error in an original estimate of a transmission time of a signal from one of the plurality of satellites;

$$\frac{\partial \overline{ρ}}{\partial t}$$

is an average line-of-sight velocity of the plurality of satellites;

$$\frac{\partial {ρ}_{j}}{\partial t}$$

is the line-of-sight velocity of the ‘j^{th}’ satellite;
a and b are orthogonal unit vectors in a tangent plane of the GPS receiver;
the apparatus being arranged to select as the reference satellite the satellite that when used as the ‘j^{th}’ satellite generates the smallest metric.

The apparatus may be arranged to calculate for each of the plurality of satellites a metric, Δⱼ₀², that is given by the following equation:

$${Δ}_{j 0}^{2} = {[ \vert {R}_{MAX} \vert \underline{a} . ( {n}_{j} - {n}_{0} ) ]}^{2} + {[ \vert {R}_{MAX} \vert \underline{b} . ( {n}_{j} - {n}_{0} ) ]}^{2} + {[ \vert Δ {t}_{MAX} \vert \vert \frac{\partial {ρ}_{j}}{\partial t} - \frac{\partial {ρ}_{o}}{\partial t} \vert ]}^{2}$$

in which:
nⱼ is the unit vector between the receiver and the ‘j^{th}’ satellite;
n₀ is a unit vector between the receiver and the satellite that is being tested as the reference;

$$\frac{\partial {ρ}_{0}}{\partial t}$$

is the line-of-sight velocity of the satellite that is being tested as the reference;

$$\frac{\partial {ρ}_{j}}{\partial t}$$

is the line-of-sight velocity of the ‘j^{th}’ satellite;
R_{MAX} is a maximum error in an original estimate of the position of the GPS receiver;
Δt_{MAX} is a maximum error in an original estimate of a transmission time of a signal from one of the plurality of satellites; and
a and b are orthogonal unit vectors in a tangent plane of the GPS receiver;
the apparatus being arranged to select as the reference satellite the satellite that, when tested as the reference satellite, generates the smallest maximum metric across all ‘j’ satellites.

The apparatus may be arranged to designate a reference satellite by selecting each of the satellites in the constellation in turn as a candidate for being the reference satellite; for each candidate, forming indications of the error that would be incorporated in each of the comparisons if that satellite were the reference; for each candidate, identifying a maximum of those errors; and designating as the reference satellite the candidate that would generate the minimum maximum error.

The apparatus may be arranged to select a subset of the satellites that are visible to the receiver to form the constellation of satellites.

The apparatus may be arranged to designate one of the subset of satellites as the reference satellite.

According to a second embodiment of the invention, there is provided a method for determining the location of a receiver in dependence on signalling events transmitted to the receiver by a satellite constellation comprising a reference satellite and one or more other satellites, the method comprising, for each of the one or more satellites, comparing an indication of the transit time of the signalling event transmitted by that satellite and an indication of the transit time of the signalling event transmitted by the reference satellite and calculating the location of the receiver in dependence on those comparisons; the method further comprising determining, for each of the satellites in the constellation, an indication of an error that would be incorporated in the comparisons if that satellite were selected as the reference satellite and selecting the reference satellite in dependence on those indications.

According to a third embodiment of the invention, there is provided a computer-readable medium encoded with instructions, that when executed by an apparatus for determining the location of a receiver in dependence on signalling events transmitted to the receiver by a satellite constellation comprising a reference satellite and one or more other satellites, cause the apparatus to, for each of the one or more satellites, compare an indication of the transit time of the signalling event transmitted by that satellite and an indication of the transit time of the signalling event transmitted by the reference satellite and calculate the location of the receiver in dependence on those comparisons; the instructions further causing the apparatus to determine, for each of the satellites in the constellation, an indication of an error that would be incorporated in the comparisons if that satellite were selected as the reference satellite and to select the reference satellite in dependence on those indications.

### BRIEF DESCRIPTION OF THE DRAWINGS

For a better understanding of the present invention, reference is made by way of example to the following drawings, in which:

FIG. 1 shows a GPS or GNSS receiver receiving signals from two satellites;

FIG. 2 illustrates an example of a signalling event;

FIG. 3 shows the steps of a method that may be used to select a reference satellite;

FIG. 4 shows the line-of-sight velocities of a satellite constellation;

FIG. 5 shows the steps of a method for selecting a reference satellite in dependence on the absolute squared residuals;

FIG. 6 shows the steps of a method for selecting a reference satellite in dependence on the average position vector of the satellites;

FIG. 7 shows the steps of a method for selecting a reference satellite in dependence on a metric based on an average position vector and an average velocity vector;

FIG. 8 shows the steps of a method for selecting a reference satellite in dependence on a metric based on an average position vector and an average velocity vector;

FIG. 9 shows the steps of a method for selecting a reference satellite-selection method in dependence on whether time or position errors dominate; and

FIG. 10 shows an example of an apparatus for calculating the position of a GPS or GNSS receiver.

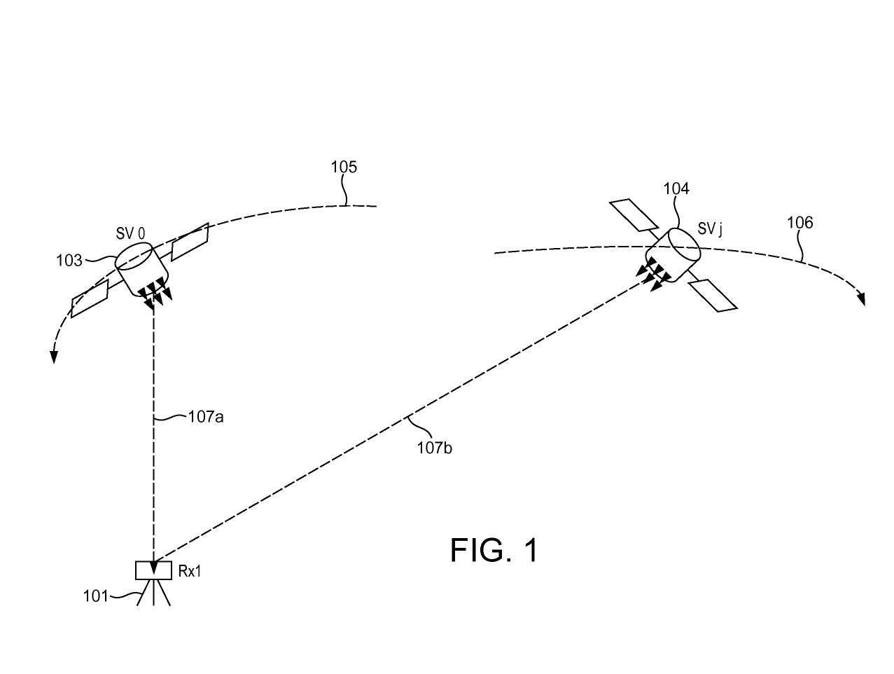

### DETAILED DESCRIPTION OF THE INVENTION

An apparatus may be capable of determining the location of a receiver in dependence on signalling events transmitted to the receiver by a satellite constellation comprising a reference satellite and one or more other satellites. The apparatus may be arranged to determine the location of the receiver by comparing an indication of the transit time of the signalling events transmitted by each of the one more satellites with an indication of the transit time of the signalling event transmitted by the reference satellite. The apparatus may then calculate the location of the receiver in dependence on those comparisons.

The apparatus may also be arranged to determine, for each of the satellites in the constellation, an indication of an error that would be incorporated in the comparisons if that satellite were selected as the reference satellite and to designate one of the satellites in the constellation as the reference satellite in dependence on those indications. This designation of the reference satellite is preferably made prior to the calculation of the receiver's location.

One or more embodiments of the invention may be implemented in a satellite navigation or GNSS system, such as GPS, GLONASS, Galileo etc. Therefore, while one or more embodiments of the invention are described herein specifically in reference to GPS systems, this is for the purpose of example only and it should be understood that the scope of the invention is not limited to GPS systems.

The apparatus for calculating the position of the receiver may include the GNSS receiver or may be located in the same piece of equipment as the receiver (from which the measured components of the transit time can be obtained). Alternatively, the apparatus may be separate from the receiver. For example, the apparatus may be a server. In this scenario the receiver suitably sends the times-of-arrival to the apparatus over a communication link. The apparatus may similarly return to the receiver the result of the location calculation. The communication link may take one of several forms commonly known in the art, such as wireless communication, packet communication, communication over a pager system, internet or other wired form of communication link.

The calculation of location may use an initial estimate of absolute time and receiver position. This initial estimate of absolute time is an estimate of the absolute time at which the signalling events used in the location calculation were transmitted from their respective satellites. The calculation may also use ephemeris information so that the estimated position of the satellite at the estimated absolute time can be determined. The estimates of receiver position may be based, for example, on a previously calculated position of the receiver or on an estimate of position received from another source, such as a cellular network or by manual input or from a data input port on the user equipment. The estimate of absolute time may similarly be based on a previously calculated value that has been updated with the time that has elapsed since, or a version of absolute time obtained from a different source from the satellite (e.g. from a cellular network), from the receiver clock, through manual input or from a data port. The ephemeris information may have been stored from a previous location calculation, may be obtained from a source other than the satellite (e.g. from a cellular network), or could be obtained directly from each satellite as required, either in a continuous data stream or as disjoint segments of the broadcast ephemeris information.

An example of an event is the occurrence of a 1 ms time transition or a code epoch or a data symbol or bit transition, or similar. The event on each satellite results in the immediate transmission of a signalling event. There are many such signalling events known to those skilled in the art. The regular repetition of an event is normal in navigation satellite systems. The signalling event may therefore be repetitive, e.g. the start of the C/A code in GPS systems, which repeats at one millisecond intervals. A repetitive signalling event can be considered to travel through space separated from neighbouring events by a wavelength distance analogous to the wavelength of a carrier signal. This wavelength is denoted as λ_{c}, and may be referred to as the code wavelength in the case that the events are separated in space by repetitions of a code.

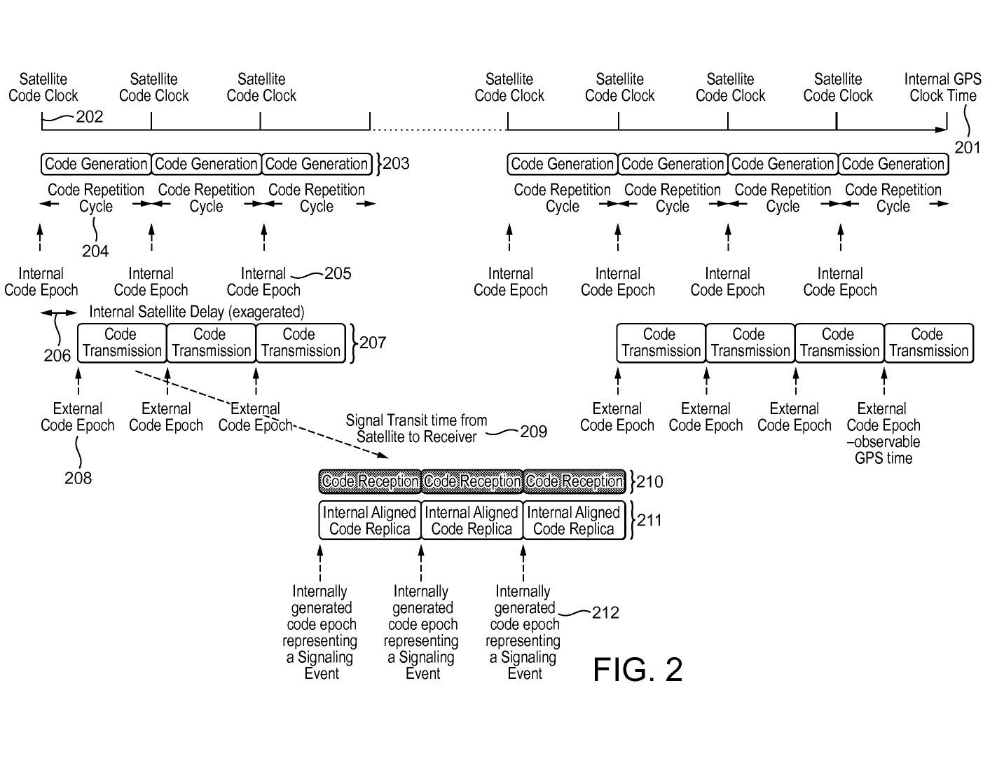

An example of a repetitive signalling event is illustrated in FIG. 2. This figure illustrates a code repetition cycle in a GPS satellite. Each satellite clock is free-running but steered towards a common absolute time reference (GPS time). The actual time of occurrence of an event is therefore determined on each satellite individually. In FIG. 2, the code repetition cycle is determined by internal GPS clock 201. Each 1 ms time transition 202 in the internal GPS clock triggers an event, causing the satellite to generate C/A code 203. The generated code incorporates a number of code repetition cycles 204, which each commence at internal code epoch 205 coinciding with the 1 ms time transitions in the internal GPS clock. The generated code is subject to a small delay 206 within the satellite before being transmitted (207). The small internal delay between code generation and code transmission results in a small offset between internal code epochs 205 and external code epochs 208. The external code epochs are spaced at 1 ms intervals and thus can be considered to represent an externally-observable version of the satellite GPS clock. The code is then subject to a further delay due to the transit time of the signal 209. The GPS receiver may then align an internal code replica 211 with the received code 210 to generate the internal code epochs 212 from which the time-of-arrival of the signalling events represented by those code epochs can be determined.

The term ‘time-of-arrival’ is used to refer to the time at which a GPS signalling event is received by the GPS receiver. The time of arrival of a signalling event may be measured with respect to a timebase within the receiver. The known timescale of the receiver clock may be used to form estimates of the time difference between the arrival of signalling events from different satellites.

The term ‘fractional’ is used herein to refer to any part or subdivision of the transit time of a satellite signalling event. The term ‘fractional’ is intended to cover any modulo value that may be defined by a satellite navigation signal, either now or in the future. The entire transit time may comprise both a fractional and integer component but the integer component (representing, for example, an integer number of code repetition intervals) may not be identifiable. The integer component may represent an integer number of code repetition intervals comprised in the transit time while the fractional part will commonly be less than the code repetition interval. The word ‘integer’ thus refers to any unobserved or ambiguous part of the transit time and is intended to cover any quotient value that may be defined by a navigation signal, either now or in the future.

The various embodiments described herein involve values represented in units of both distance and time. These values often relate to the transit of GNSS signals, which have a known speed (the speed of light), and so can generally be readily converted from values expressed in terms of distance into values expressed in terms of time and vice versa. The equations given herein are generally expressed in terms of time as this is the basis upon which the satellite signal receiver makes its measurements of the arrival of signalling events. However, equivalent distance quantities may be derived through multiplication by the speed of light. The equations herein can therefore readily be converted between being expressed in terms of distance and being expressed in terms of time and are not intended to be limited in scope to the particular form in which they are expressed below.

### Selection of the Reference Satellite

One or more embodiments of the invention may implement a method for selecting the best available reference satellite. The selection procedure may be varied depending upon the computational resources available to the user and prior knowledge of the most significant error source.

There are several different metrics that might be used in the selection of an optimized choice for the ‘reference’ satellite and its measurement. One prior art approach is to select as a reference the satellite that is nearest the receiver's zenith (i.e. the satellite that has the highest elevation angle relative to the receiver's position). This corresponds to selecting the satellite with the minimum value of |\dot{ρ}₀|. This may not be optimum for a given constellation as it may, in one example, unbalance the truncation errors in establishing the integer numbers of code repetition wavelengths in the satellite to user distance. Furthermore, it does not consider any effects due to partitioning the available measurement errors into a portion allocated to absolute time errors and a separate portion due to user location errors. Such allocation is a desirable means to build ‘a priori’ knowledge concerning the sizes of the unknown parameters into the solution.

A selection of algorithms that might be used to select the reference satellite, which may provide improved tolerance to user position and absolute time errors, are described below. The selection metrics used below are more responsive to the status of the complete satellite constellation rather than only using one feature of one satellite.

### Minimizing Velocity Variation

One suitable metric for the selection of a best reference satellite involves minimizing the variation in satellite line-of-sight velocities from that of the reference satellite. For a constellation with N+1 members, a suitable metric is formed from the average of the differences between the line-of-sight velocities of each satellite and a reference satellite, where the subscript ‘0’ refers to the reference satellite:

$$\begin{matrix}υ {\vert}_{min over selection of sat ‘ 0 ’} ≡ \frac{1}{( N + 1 )} {\sum }_{\begin{matrix}j = 1 \\ j \neq 0\end{matrix}}^{N} ( {\dot{ρ}}_{j} - {\dot{ρ}}_{0} ) \\ = \frac{1}{( N + 1 )} {\sum }_{j = 0}^{N} ( {\dot{ρ}}_{j} ) - {\dot{ρ}}_{0} \\ = \{ {\dot{ρ}}_{ave} - {\dot{ρ}}_{0} \}\end{matrix} \qquad ( 14 )$$

The re-arrangement above shows that this process is equivalent to forming the visible constellation average and subtracting the line-of-sight velocity of the chosen reference satellite. The process can be simply summarized as making the choice of the reference satellite based on having its line-of-sight velocity closest to the average of the visible constellation.

The metric in equation (14) has the beneficial effect of providing a reference satellite selection which follows the average of the line-of-sight satellite velocities. If the satellite constellation is evenly balanced with respect to the line-of-sight velocities, that is, the average line-of-sight velocity is near zero, the best reference satellite is the satellite having the line-of-sight velocity closest to zero, corresponding to the selection of the satellite nearest to the receiver's zenith. However, few constellations have such characteristics and it is more likely that the constellation has an unbalanced line-of-sight velocity profile, which is not centred on zero. In such cases, the average line-of-sight velocity can be significantly different from zero. The best selection for the reference satellite is the one which has a line-of-sight velocity closest to the constellation average. The final line in equation (14) demonstrates the ease of finding the best satellite using this criterion. The metric may work well for unbalanced constellations by minimizing the variations between the single difference satellite velocities used in equation (5).

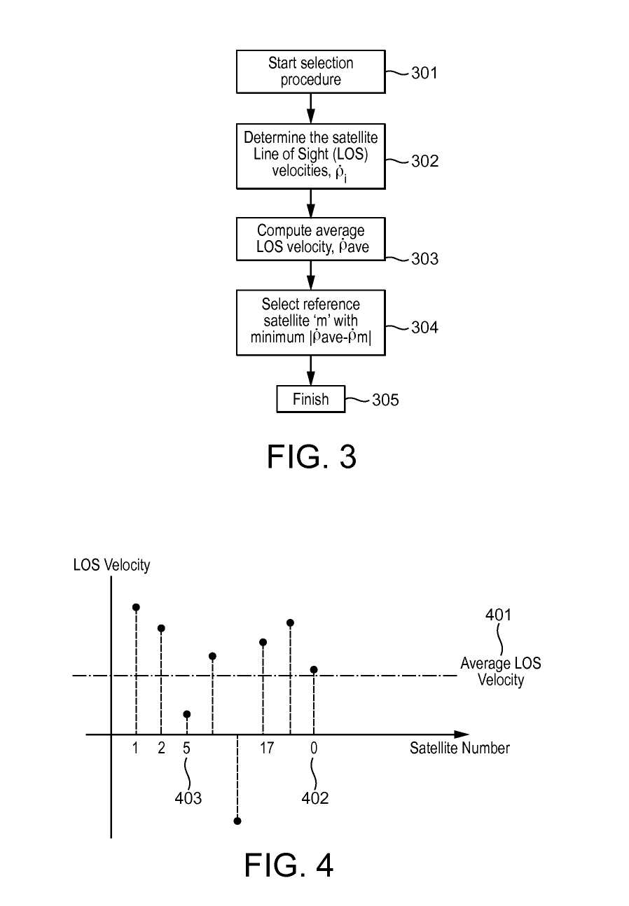

One benefit of selecting the reference satellite to be the one having the closest line-of-sight velocity to an average velocity of the constellation is that it minimises that portion of the available error required to compensate for the error in the estimate of absolute time. This procedure is illustrated in FIG. 3.

Step 301 commences the procedure. In step 302, the line-of-sight velocities of the used constellation are determined from the estimate of absolute time, user location and the provided ephemeris information. In step 303, the average velocity of the constellation is computed. If this is significantly different from zero, it confirms that the constellation is unbalanced. In step 304, a search is made through the values of the satellite line-of-sight velocities to find that satellite (with subscript ‘m’) that has a line-of-sight velocity closest to the computed average value. The procedure concludes in step 305.

A typical unbalanced satellite constellation and the best reference satellite within that constellation are illustrated in FIG. 4. Here the average line-of-sight velocity is illustrated as item 401 and the satellite with the nearest velocity to this is 402, marked as satellite number ‘0’. A selection of the reference satellite nearest to the receiver's zenith, that is, the one with the lowest line-of-sight velocity, would have resulted in the choice of satellite number 5 at 403.

A second metric, for the determination of a best reference satellite selection, is formed by the sum of the norms (or a power of k of them) of the single difference line-of-sight velocities:

$${\tilde{υ}}^{k} {\vert}_{min over selection 0} ≡ \frac{1}{N} {\sum }_{\begin{matrix}j = 1 \\ j \neq 0\end{matrix}}^{N} {\vert ( {\dot{ρ}}_{j} - {\dot{ρ}}_{0} ) \vert}^{k} \qquad ( 15 )$$

This equation also selects, as the reference satellite, the satellite that is in the middle of the velocity spread, but it places additional weight on the larger satellite to reference satellite velocity differences. This emphasis increases with the value of k.

A preferred embodiment takes a more general approach to the determination of a best reference satellite. In the following description, ‘a priori’ knowledge of the position and time estimation errors can be built into the selection method.

### A Priori Knowledge of Position and Time Errors

An algorithm for selecting the reference satellite may beneficially incorporate a priori knowledge of the maximum errors likely to be present in the initial estimates of receiver position and absolute time. The maximum expected errors may be known from the source of the original estimates. For example, the original position estimate may have been selected to be the centre of a cell in a cellular network within which the GNSS receiver is known to be located. The maximum error in the original estimate of receiver position may then be determined from the size of that cell. Similarly, the original time estimate may have been obtained from a cellular base station's copy of an absolute time. Some networks, e.g. CDMA, require each base station to be synchronised to GPS time within a maximum acceptable error. In such a scenario, the maximum error in the estimate of absolute time will also be known. The a priori knowledge of the maximum errors may be exploited, together with knowledge of the acceptable limits that are placed on initial errors that by the convergence zone for the location algorithm, to determine the most appropriate satellite to use as the reference.

The time of arrival of a signal from satellite ‘j’, emitted at absolute time, t, measured by the user receiver's clock, can be determined using equation (1), which is repeated below:

$${t}_{rx , j} = {t}_{gps} + \frac{{D}_{j} ( t )}{c} + \frac{( {B}_{U} - {B}_{SV , j} )}{c} + \frac{( {d}_{iono , j} + {d}_{tropo , j} )}{c} + {ɛ}_{j} \qquad ( 1 )$$

A variable, χⱼ, may be defined that is a calculated measure of absolute time, based on the reception time of an identified signalling event. The reception time of the signalling event is used to calculate absolute time by subtracting the transit time due to the range between user and satellite, correcting for the satellite clock bias. This estimate remains offset by the user receiver common clock bias, B_{U}, and certain measurement errors (ionospheric, tropospheric delays and noise). Thus, χⱼ is an absolute time, based on the transmission of the signalling event and on the scale of the receiver clock. The calculation should reveal the same value of absolute time for every satellite provided that the correct range measurement (to each satellite) is used, i.e. for all ‘j’ satellites and for the reference satellite. χ₀ may be calculated as follows:

$${χ}_{j} = {t}_{rx , j} - \frac{{D}_{j}}{c} + \frac{{B}_{SV , j}}{c} \\ and \\ {χ}_{0} = {t}_{rx , 0} - \frac{{D}_{0}}{c} + \frac{{B}_{SV , 0}}{c} \qquad ( 16 )$$

Single-differences may be constructed to remove the receiver bias and form an absolute time difference error, at ∂tⱼ, between the j^{th} satellite and the reference satellite:

$$\partial {t}_{j} = ( {χ}_{j} + \frac{{B}_{U}}{c} + \frac{( {d}_{iono , j} + {d}_{tropo , j} )}{c} + {ɛ}_{j} ) - ( {χ}_{0} + \frac{{B}_{U}}{c} + \frac{( {d}_{iono , 0} + {d}_{tropo , 0} )}{c} + {ɛ}_{0} ) = ( {χ}_{j} - {χ}_{0} ) - ( {\tilde{ɛ}}_{j} - {\tilde{ɛ}}_{0} ) \qquad ( 17 )$$

In equation (17), the user receiver common bias has been eliminated by subtraction, and the ionospheric and tropospheric delays have been partially cancelled. The residual (ionospheric and tropospheric) delays are subsumed into the noise terms \tilde{ε}. Consequently, equation (16) should result in a nominal value for ∂tⱼ at of zero provided that the measurement errors are zero, with the additional condition that the values of Dⱼ and D₀ are correct.

An ideal reference satellite may be formed from a weighted combination of the χs for the visible constellation. The ideal reference may be the satellite having the property:

χ₀=Σⱼwⱼχⱼ (18)

subject to the constraint:

Σⱼwⱼ=1 (19)

The constraint ensures that the B terms cancel in the expression for χ₀.

Initial estimates, \hat{χ}ⱼ, of the χⱼ values of may be based on:

(a) time of arrival measurements; and
(b) estimated (initial) values of the satellite to user range using estimated absolute time. The initial values of \hat{χ}ⱼ are therefore unlikely to result in a zero since they each incorporate an error due to an error in receiver location and an error in satellite location (due to errors in absolute time).

A limit value ∂tₘₐₓ can be placed on ∂\hat{t}ⱼ considering the allowable error limits set by a rounding operation. A rounding operation should select the correct value for absolute time providing that ∂tₘₐₓ is set at half the inter-event time interval (which is half of the difference between the ambiguous values). A convergence zone can be identified in which the estimated errors as defined by ∂\hat{t}ⱼ are all less than half the inter-event time interval (this interval is λ_{code}/2c, which for GPS C/A code is ½ ms).

In order to minimize the probability that any ∂\hat{t}ⱼ exceeds the limit, a reference satellite which is a function of some or all (for example, a form of average) of the ∂\hat{t}ⱼ values is preferably selected. One optimum choice for the reference satellite is to select as the reference the satellite that generates a minimum error. One suitable metric for determining this is the L₂ metric:

E=Σⱼ∂\hat{t}ⱼ² (20)

which yields:

$${\hat{χ}}_{0} = \frac{1}{N} {\sum }_{i} {\hat{χ}}_{i} \qquad ( 21 )$$

So a satellite corresponding to a mean of the χⱼ values should minimise the least squares error. In reality, however, it is unlikely that a single one of the satellites will correspond exactly to the mean χⱼ value. One embodiment option is to construct a virtual composite reference satellite, having a χ corresponding exactly to the mean value. This may not be a sensible option in practice because at this stage of the algorithm the times-of-arrival are still ambiguous. These ambiguities can be resolved once one of the satellites has been selected as the reference, either by selecting the most appropriate time-of-arrival relative to the reference satellite or by rounding, once a comparison with the reference satellite has been performed (as has been explained above). However, if a composite satellite is formed by adding together N ambiguous terms, the result is ambiguous to ΔT/N (where 9ΔT is the inter-event interval).

For example, if the ambiguities are [69 70 70 70 72] and ΔT is 1 millisecond, then the mean is 70.2, which is not an integer. This can be avoided by multiplying each equation in the geometry matrix by N but this causes a corresponding reduction in the convergence radius. It is therefore preferable to select an actual single reference satellite in order to avoid these problems and two examples of how this might be achieved are described below.

One preferred method of choosing the reference satellite can be understood by considering the rounding operation expressed by equation (9), which is repeated below:

|(\tilde{τ}ⱼ−\hat{D}ⱼ(t)/c)−(\tilde{τ}₀−\hat{D}₀(t)/c)|_{mod 1ms}−(\tilde{ε}ⱼ−\tilde{ε}₀) (9)

This equation holds true if the values of receiver position and absolute time are correct, so that \hat{D}ⱼ(t) and \hat{D}₀(t) are the correct values. However, in practice there will be an error in the estimates of receiver position and absolute time. One of the steps in the method defines a new variable:

ηⱼ=(\tilde{τ}ⱼ−\hat{D}ⱼ(t)/c) (22)

Δⱼ₀=ηⱼ−η₀ (23)

As before, when any Δⱼ₀ approaches λ_{c}/2c (½ ms for GPS C/A code), there is the risk of rounding to the incorrect millisecond, causing the algorithm to fail. One reason for such failure may be due to the contribution of the error components, ε. To minimize the chances of this, one possible approach is to choose the reference satellite so as to minimise the maximum value of Δⱼ₀ for every given j.

The method provides correct solutions for the location solutions provided all of the Δⱼ₀ are less than λ_{c}/2c. As this threshold value is approached, the remaining errors in the measurement (such as ionospheric, tropospheric and measurement noise) produce a (usually small) region where there is a risk of an incorrect choice of integer (λ_{c}/c) in the signal transit time. The method minimizes this possibility through the process choosing the reference satellite which minimizes the maximum value of Δⱼ₀ for every member or subset of members of the visible satellite constellation. The method includes the step, or equivalent, of forming a metric:

l=minⱼmax₀(|ηⱼ−η₀|²) (24)

The method then selects the reference satellite “0” so that index l is that with the minimum value of the absolute squared residual. This can be calculated directly since the values needed to compute equation (24) are known. For example, a direct method tests each possible reference satellite in turn and computes the RMS spread (or maximum absolute residual) of the differenced measurements. The candidate with the minimum value of the maximum absolute residual may be selected as the reference satellite.

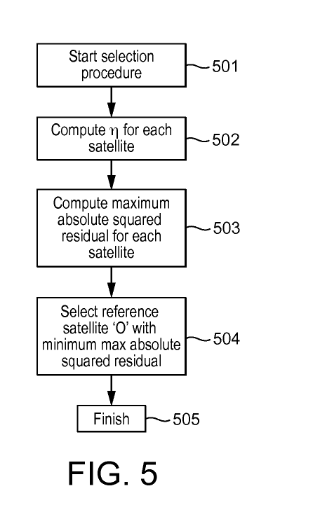

An example of the steps that may be employed for selecting a reference satellite by means of the minimum absolute squared residual is shown in FIG. 5. The procedure starts in step 501. In step 502 a value ηⱼ is computed for each satellite using the measured arrival times, estimated ranges and known satellite clock bias. In step 503 the maximum absolute squared residual is computed for each satellite by comparing its ηⱼ with the respective ηⱼ for each of the other satellites in accordance with equations 22 and 23. In step 504, the satellite for which the maximum absolute squared residual was the lowest is selected as the reference satellite. The procedure then terminates in step 505.

A second preferred method to select the reference satellite is to use the GPS Jacobian (observation matrix) to examine the make-up of the measure of GPS time, χⱼ. This can be done by looking at a single row of the matrix equation (since the B_{U} terms are identical for a common receiver, and will be cancelled by taking single differences, this term can be set to zero in the equation below without loss of generality):

$$H . Δ x = r \\ [ \begin{matrix}{n}_{x}^{j} & {n}_{y}^{j} & {n}_{z}^{j} & {\dot{ρ}}_{j}\end{matrix} ] [ \begin{matrix}Δ x \\ Δ y \\ Δ z \\ Δ t\end{matrix} ] = n . Δ x + \frac{\partial ρ}{\partial t} Δ t = {χ}_{i} \qquad ( 25 )$$

Summing equation (25) over all of the j satellites in accordance with equation (21) gives:

$${χ}_{ref} = n . Δ x + \frac{\partial \overline{ρ}}{\partial τ} Δ t \qquad ( 26 )$$

where the bar denotes average value.

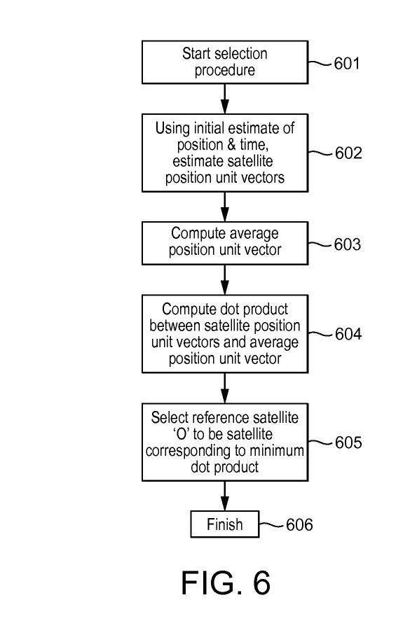

Equation (26) demonstrates that the ‘mean satellite’ can be defined by a linear combination of the average unit vector to the satellites and the average line-of-sight velocity, the combination being performed in dependence on the errors in the initial estimates of receiver position and absolute time. One option is to select the satellite whose line-of-sight velocity is closest to the average line-of-sight velocity. This option may be appropriate if time is the dominant error factor. This provides additional confirmation that the satellite having the closest line-of-sight velocity to the average line-of-sight velocity of the satellite constellation (as shown in FIGS. 3 and 4) is an appropriate candidate for the reference satellite. Another option is to select as the reference satellite the satellite that is closest to the mean vector of the satellite's positions (i.e. the satellite whose vector position generates the smallest dot product with the mean vector position). This option may be appropriate if receiver position uncertainty is the main error factor. The steps involved in selecting the reference satellite to be the satellite whose vector position is closest to the constellation average are shown in FIG. 6.

The procedure shown in FIG. 6 commences at step 601. In step 602 the satellite position vectors (which may suitably be the unit vectors from the receiver to each of the satellites, as shown in equation (26)) are determined. In step 603, the average position vector is computed. In step 604, dot products between the average position vector and each of the satellite position vectors are computed. The minimum of these dot products is determined and the satellite that generated that dot product selected as the reference satellite in step 605. The procedure finishes in step 606.

The general case where the errors are mixed is more complex but may be addressed by defining the following sets:

Δx(φ)=|R_{MAX}|(a cos φ+b sin φ)

Δt=Δt_{MAX} (27)

where:
a and b are any unit vectors in the receiver's local tangent plane;
a cos φ+b sin φ defines a unit vector in the ‘ab’ plane at an angle φ to the a unit vector;
R_{MAX} is the maximum expected receiver position error; and
Δt_{MAX} is the maximum expected error in the original estimate of GPS time.

The maximum expected errors may be known from the source of the original estimates. For example, the original position estimate may have been selected to be the centre of a cell in a cellular network within which the receiver is known to be located. The maximum error in the original estimate of receiver position may then be determined from the size of that cell. Similarly, the original time estimate may have been obtained from a cellular base station's copy of absolute time. Some networks, e.g. CDMA require each base station to be synchronised to GPS time within a maximum acceptable error. In such a scenario the maximum error for GPS time will also be known.

$${Δ}_{j} ( φ ) = \vert {R}_{MAX} \vert ( \underline{a} cos φ + \underline{b} sin φ ) \cdot ( n - {n}_{j} ) + \vert \frac{\partial \overline{ρ}}{\partial t} - \frac{\partial {ρ}_{j}}{\partial t} \vert \vert Δ {t}_{MAX} \vert \qquad ( 28 )$$

Then:

Δⱼ²=∫Δⱼ²(φ)dφ (29)

And:

$${Δ}_{j}^{2} = {[ \vert {R}_{MAX} \vert \underline{a} . ( \overline{n} - {n}_{j} ) ]}^{2} + {[ \vert {R}_{MAX} \vert \underline{b} . ( \overline{n} - {n}_{j} ) ]}^{2} + {[ \vert Δ {t}_{MAX} \vert \vert \frac{\partial \overline{ρ}}{\partial t} - \frac{\partial {ρ}_{j}}{\partial t} \vert ]}^{2} \qquad ( 30 )$$

Where:

n̅ is a mean of the unit vectors between the receiver and the satellite;
nⱼ is the unit vector between the receiver and the ‘j^{th}’ satellite;

$$\frac{\partial \overline{ρ}}{\partial t}$$

is the average time-of-sight velocity of the satellites; and

$$\frac{\partial {ρ}_{j}}{\partial t}$$

is the line-of-sight velocity of the ‘j^{th}’ satellite.

The resultant choice of satellite for the reference is that with the smallest Δⱼ².

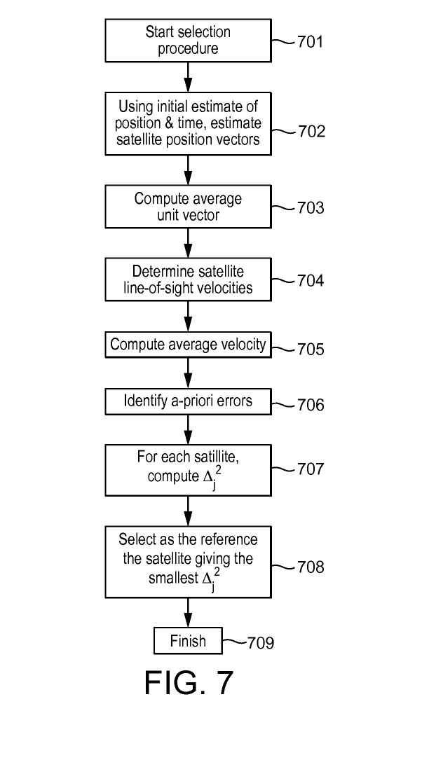

An example of a method suitable for selecting a reference satellite in the case where the errors are distributed between the original estimate of receiver position and the original estimate of absolute time is illustrated in FIG. 7. The procedure commences in step 701. In step 702 the unit vectors between the receiver and each of the satellites are determined. In step 703, the average unit vector is computed. In steps 704 and 705, the satellite line-of-sight velocities are determined and the average line-of-sight velocity is computed. The a priori errors in the initial estimates of receiver position and absolute time are identified in step 706. In step 707, Δⱼ² is calculated for each satellite in accordance with equation (40), depending on which metric is being used. The satellite producing the smallest value for Δⱼ² is then selected as the reference in step 708. The procedure finishes in step 709.

The metrics given above are examples of suitable values that might be calculated in order to distinguish between different satellites on the basis of the a priori errors. These specific metrics are given for the purpose of example only, and it should be understood that other metrics might be equally suitable for evaluating how different choices for the reference satellite affect the susceptibility of the method to the a priori errors. An example is the selection of the reference satellite in a scenario when the errors are mixed between position and time errors, when it is equally suitable to select as the reference the satellite which minimizes the average error (see equation 39) or that which minimizes the maximum error (see below).

In order to minimize the maximum error, equations 28 to 30 may be replaced by the following alternatives:

$${Δ}_{0 j} ( φ ) = \vert {R}_{MAX} \vert ( \underline{a} cos φ + \underline{b} sin φ ) \cdot ( {n}_{0} - {n}_{j} ) + \vert \frac{\partial {ρ}_{0}}{\partial t} - \frac{\partial {ρ}_{j}}{\partial t} \vert \vert Δ {t}_{MAX} \vert \qquad ( 31 )$$

Then:

Δⱼ₀²=∫Δⱼ²(φ)dφ (32)

And:

$${Δ}_{j 0}^{2} = {⌈ \vert {R}_{MAX} \vert \underline{a} . ( {n}_{j} - {n}_{0} ) ⌉}^{2} + {⌈ \vert {R}_{MAX} \vert \underline{b} . ( {n}_{j} - {n}_{0} ) ⌉}^{2} + {[ \vert Δ {t}_{MAX} \vert \vert \frac{\partial {ρ}_{j}}{\partial t} - \frac{\partial {ρ}_{c}}{\partial t} \vert ]}^{2} \qquad ( 33 )$$

Where:

n₀ is a unit vector between the receiver and the satellite that is being tested as the reference; and

$$\frac{\partial {ρ}_{0}}{\partial t}$$

is the line-of-sight velocity of the satellite that is being tested as the reference.

In this procedure we evaluate:

k=min₀maxⱼ(Δⱼ₀²) (34)

So, each satellite is tested in turn for its suitability as the reference satellite by evaluating Δⱼ₀² for that satellite as the reference in respect of all other satellites ‘j’ in the set. For each satellite being tested as the reference, the maximum expected error is then determined from these calculated Δⱼ₀² values. The reference satellite that has the smallest of the estimated ‘worst-case’ errors, as indicated by the Δⱼ₀² values, is then selected as the reference.

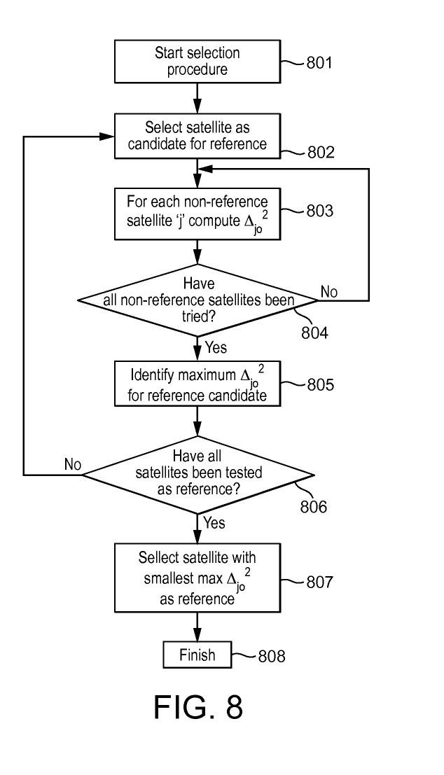

This procedure is illustrated in FIG. 8. The procedure commences in step 801. In step 802 a satellite is selected as a candidate for the reference satellite. With all the other satellites as non-reference ‘j’ satellites, Δⱼ₀² is then evaluated for this candidate as the reference (803) until all non-reference satellites have been evaluated (804). Once all non-reference satellites have been evaluated, the maximum of all the Δⱼ₀² values for the reference candidate is evaluated (805). This process is repeated until all available satellites have been evaluated as candidates for the reference (806). The minimum of all the maximum Δⱼ₀² values is then identified and the satellite that generated that minimum Δⱼ₀² value as a reference candidate is selected as the reference (807). The procedure finishes in step 808.

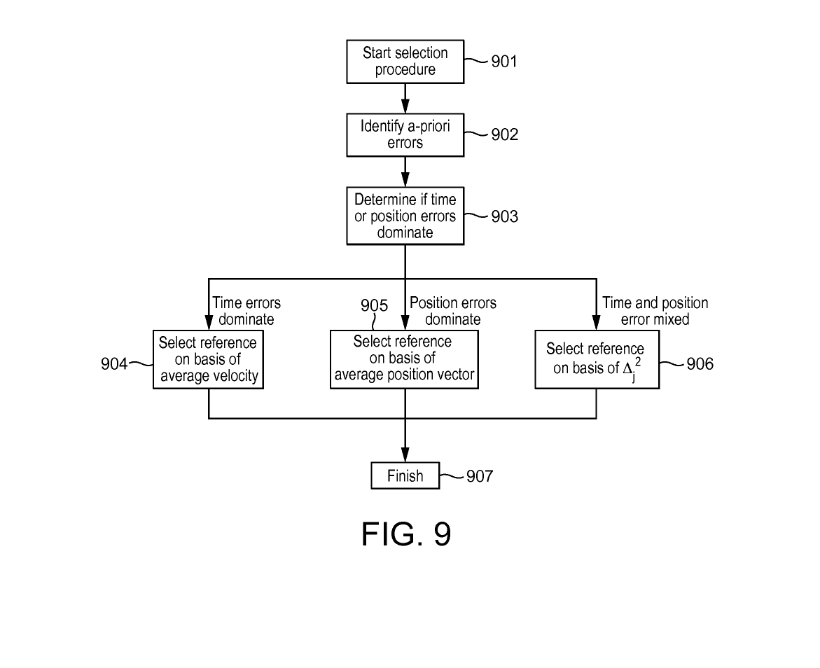

The exact method used to select the reference satellite may be chosen in dependence on the a priori errors associated with the original estimates of receiver position and absolute time, as shown in FIG. 9. If one or other of the error sources dominates (e.g. if either position or time account for 80% or higher of the total a priori error) then the reference satellite may be selected solely on the basis of the average position vector or the average line-of-sight velocity (see steps 903 to 905). However, if neither form of error dominates, so that both the initial receiver position estimate and absolute time estimate make a contribution to the overall error (which is likely to be the case in practice) then the reference satellite selection is preferably made by considering both error sources, e.g. by calculating values of Δⱼ² or Δⱼ₀² for each satellite.

### Measurement Noise Correlation

The use of a reference satellite in the single difference method causes correlations between the measurements. The measurement noise correlation matrix for the single difference method is the sum of a diagonal matrix and a matrix in which every element is 1. The diagonal elements of the first matrix are the noise variances for each measurement. The second matrix may be multiplied by the variance for the reference satellite. Because the reference satellite has an impact on all the measurements, it is prudent to choose the satellite with the minimum measurement noise for the last iteration of the single difference method. This minimizes the impact of the reference satellite on the position accuracy and does not impact the convergence zone.

### Satellite Subset Selection

In one or more embodiments, a subset of the visible satellites may be selected as the satellites in dependence on which the location of the receiver is determined. In some embodiments, smaller subsets that maximise the convergence zone may be advantageously selected during early iterations of the method to be replaced by larger subsets during later iterations, when the size of the convergence zone is no longer as critical. Suitably the reference satellite is designated from one of the satellites comprised in the subset. The designation of the reference satellite may change from one iteration of the algorithm to the next, particularly when different subsets are being used in those iterations.

### Apparatus Example

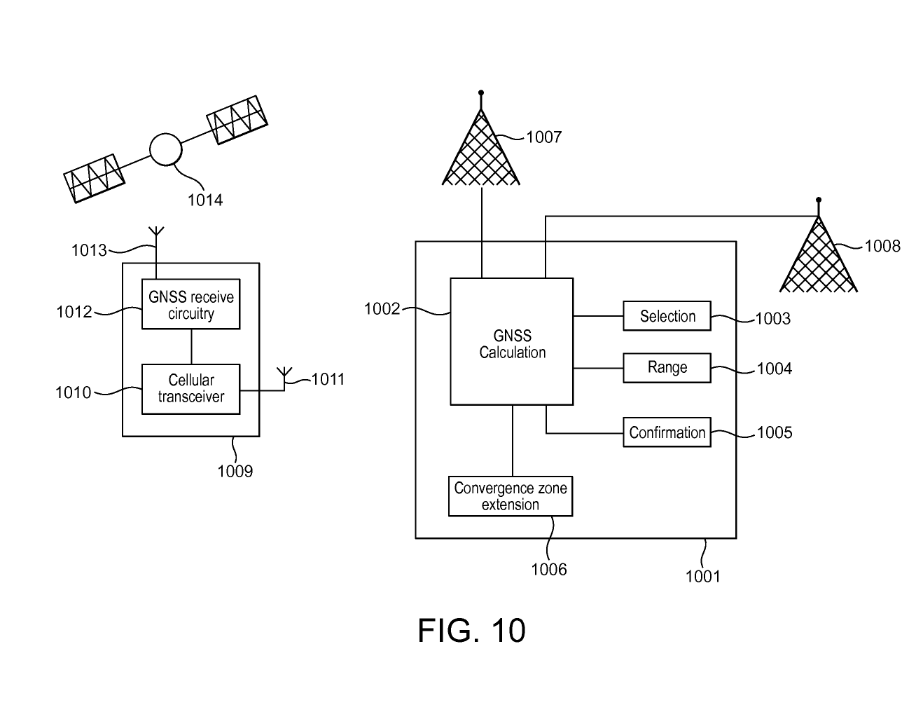

An example of an apparatus suitable for implementing the location-determination algorithms described herein is shown generally in FIG. 10. The apparatus is shown generally at 1001. The algorithm may be implemented by a receiver or by a separate piece of apparatus, such as a server. In this example, the apparatus is located in a server that forms part of a cellular network. This is for the purposes of example only, and in other preferred embodiments the apparatus may be a handheld device.

In FIG. 10, a GNSS receiver is shown at 1009. The receiver comprises a GNSS antenna 1013 for receiving signalling events from a satellite 1014. The receiver also comprises GNSS receiver circuitry 1012 that is capable of identifying the times-of-arrival of signalling events transmitted by the satellite. The receiver may comprise a cellular transceiver 1009 and an associated antenna 1011 by means of which the receiver can transmit the measured times-of-arrival to server 1001 for processing. In this example, the server is shown as part of the cellular network and connected to radio tower 1007.

The server location calculation unit 1002 is connected to receive times-of-arrival information from the GNSS receiver via radio tower 1007 and to receive ephemeris information from radio tower 1008, which has a clear view of the sky for receiving GNSS signals from one or more satellites. The location calculation unit is also connected to a selection unit 1003, a range estimation unit 1004, a confirmation unit 1605 and an algorithm selection unit 1006. The selection unit may be arranged to select the satellite subsets and the reference satellite. The range estimation unit may be arranged to estimate the distances between the receiver and each of the satellites by working out the satellite positions at the current estimate of GPS time. The confirmation unit may be arranged to perform the DoP and other confirmation calculations that check the validity of the updated position and absolute time estimates generated by the algorithm. The algorithm selection unit may be arranged to select the algorithm by means of which the reference satellite is to be designated, e.g. in dependence on the likely errors in the a priori estimates of receiver position and absolute time. The calculation unit is suitably arranged to maintain overall control of the algorithm by passing data between the various other functional blocks and by performing the actual location calculation. The calculation unit is preferably capable of performing a standard location calculation (linearized or otherwise) in addition to one or more of the single-difference algorithms described above.

The apparatus shown in FIG. 10 is shown illustratively as comprising a number of interconnected functional blocks. This is for illustrative purposes and is not intended to define a strict division between different parts of hardware on a chip. In practice, the apparatus preferably uses a microprocessor acting under software control for implementing the algorithms described herein. In some embodiments, the algorithms may be performed wholly or partly in hardware. It may, for some examples, be advantageous in some implementations to provide dedicated hardware for performing some of the calculations as is known in the art.

The applicants hereby disclose in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems discloses herein, and without limitation to the scope of the claims. The applicants indicate that aspects of the present invention may consist of any such feature or combination of features. In view of the foregoing description it will be evident to a person skilled in the art that various modifications may be made within the scope of the invention.

1. An apparatus for determining the location of a receiver in dependence on signalling events transmitted to the receiver by a satellite constellation comprising a reference satellite and one or more other satellites, the apparatus being arranged to:
for each of the one or more other satellites, compare an indication of the transit time of a signalling event transmitted by that satellite and an indication of the transit time of a signalling event transmitted by the reference satellite; and
calculate the location of the receiver in dependence on those comparisons;
the apparatus being further arranged to determine, for each of the satellites in the constellation, an indication of an error that would be incorporated in the comparisons if that satellite were selected as the reference satellite and to designate one of the satellites in the constellation as the reference satellite in dependence on those indications.

2. An apparatus as claimed in claim 1, wherein apparatus is arranged to estimate a transmission time for the signalling events transmitted by each satellite and estimate a location of the receiver.

3. An apparatus as claimed in claim 2, wherein the apparatus is arranged to compare the indications of the transit times in dependence on the estimated transmission time of the signalling event transmitted by the satellite, the estimated transmission time of the signalling event transmitted by the reference satellite and the estimated location of the receiver.

4. An apparatus as claimed in claim 3, wherein the apparatus is arranged to determine an indication of the error that would be incorporated in the comparisons in dependence on an error comprised in the estimates of transmission time and/or the estimate of receiver location.

5. An apparatus as claimed in claim 1, wherein the apparatus is arranged to use, as the indication of the transit time of a signalling event, a time-of-arrival of that signalling event at the receiver.

6. An apparatus as claimed in claim 2, wherein the apparatus is arranged to use, as the indication of the transit time of a signalling event, an estimated distance between the receiver and the satellite that transmitted that signalling event.

7. An apparatus as claimed in claim 6, wherein the apparatus is arranged to estimate the distance between the receiver and the satellite in dependence on the estimated time of transmission of the signalling event transmitted by that satellite and the estimated location of the receiver.

8. An apparatus as claimed in claim 1, wherein the apparatus is arranged to determine an average line-of-sight velocity for the satellites in the constellation.

9. An apparatus as claimed in claim 8, wherein the apparatus is arranged to designate, as the reference satellite, the satellite having a line-of-sight velocity that is closest to the average line-of-sight velocity.

10. An apparatus as claimed in claim 1, wherein the apparatus is arranged to determine a direction vector corresponding to an average of the direction vectors from the receiver to each satellite in the constellation.

11. An apparatus as claimed in claim 10, wherein the apparatus is arranged to designate, as the reference satellite, the satellite for which the direction vector from the receiver to that satellite is closest to the average direction vector.

12. An apparatus as claimed in claim 8, wherein the apparatus is arranged to designate, as the reference satellite, the satellite in the constellation having either:
the closest line-of-sight velocity to the average line-of-sight velocity; or
the direction vector to the receiver that is closest to the average direction vector;
in dependence on the relative magnitudes of an error in the estimate of the location of the receiver and an error in the estimates of the transmission times.

13. An apparatus as claimed in claim 8, wherein the apparatus is arranged to designate as the reference satellite the satellite of the plurality of satellites having an optimum combination of line-of-sight velocity and direction vector in relation to the average line-of-sight velocity and average direction vector.

14. An apparatus as claimed in claim 8, wherein the apparatus is arranged to calculate for each of the plurality of satellites a metric, Δⱼ², that is given by the following equation:
$${Δ}_{j}^{2} = {⌈ \vert {R}_{MAX} \vert \underline{a} . ( \overline{n} - {n}_{j} ) ⌉}^{2} + {⌈ \vert {R}_{MAX} \vert \underline{b} . ( \overline{n} - {n}_{j} ) ⌉}^{2} + {[ \vert Δ {t}_{MAX} \vert \vert \frac{\partial \overline{ρ}}{\partial t} - \frac{\partial {ρ}_{j}}{\partial t} \vert ]}^{2}$$
in which:
n̅ is a mean of the unit vectors between the receiver and the plurality of satellites;
nⱼ is the unit vector between the receiver and the ‘j^{th}’ satellite;
R_{MAX} is a maximum error in an original estimate of the position of the GPS receiver;
Δt_{MAX} is a maximum error in an original estimate of a transmission time of a signal from one of the plurality of satellites;
$$\frac{\partial \overline{ρ}}{\partial t}$$
is an average line-of-sight velocity of the plurality of satellites;
$$\frac{\partial {ρ}_{j}}{\partial t}$$
is the line-of-sight velocity of the ‘j^{th}’ satellite;
a and b are orthogonal unit vectors in a tangent plane of the GPS receiver;
the apparatus being arranged to select as the reference satellite the satellite that when used as the ‘j^{th}’ satellite generates the smallest metric.

15. An apparatus as claimed in claim 1, wherein the apparatus is arranged to calculate for each of the plurality of satellites a metric, Δⱼ₀², that is given by the following equation:
$${Δ}_{j 0}^{2} = {[ \vert {R}_{MAX} \vert \underline{a} . ( {n}_{j} - {n}_{0} ) ]}^{2} + {[ \vert {R}_{MAX} \vert \underline{b} . ( {n}_{j} - {n}_{0} ) ]}^{2} + {[ \vert Δ {t}_{MAX} \vert \vert \frac{\partial {ρ}_{j}}{\partial t} - \frac{\partial {ρ}_{c}}{\partial t} \vert ]}^{2}$$
in which:
nⱼ is the unit vector between the receiver and the ‘j^{th}’ satellite;
n₀ is a unit vector between the receiver and the satellite that is being tested as the reference;
$$\frac{\partial {ρ}_{0}}{\partial t}$$
is the line-of-sight velocity of the satellite that is being tested as the reference;
$$\frac{\partial {ρ}_{j}}{\partial t}$$
is the line-of-sight velocity of the ‘j^{th}’ satellite;
R_{MAX} is a maximum error in an original estimate of the position of the GPS receiver;
Δt_{MAX} is a maximum error in an original estimate of a transmission time of a signal from one of the plurality of satellites; and
a and b are orthogonal unit vectors in a tangent plane of the GPS receiver;
the apparatus being arranged to select as the reference satellite the satellite that, when tested as the reference satellite, generates the smallest maximum metric across all ‘j’ satellites.

16. An apparatus as claimed in claim 1, wherein the apparatus is arranged to designate a reference satellite by:
selecting each of the satellites in the constellation in turn as a candidate for being the reference satellite;
for each candidate, forming indications of the error that would be incorporated in each of the comparisons if that satellite were the reference;
for each candidate, identifying a maximum of those errors; and
designating as the reference satellite the candidate that would generate the minimum maximum error.

17. An apparatus as claimed in claim 1, wherein the apparatus is arranged to select a subset of the satellites that are visible to the receiver to form the constellation of satellites.

18. An apparatus as claimed in claim 17, wherein the apparatus is arranged to designate one of the subset of satellites as the reference satellite.

19. A method for determining the location of a receiver in dependence on signalling events transmitted to the receiver by a satellite constellation comprising a reference satellite and one or more other satellites, the method comprising:
for each of the one or more satellites, comparing an indication of the transit time of the signalling event transmitted by that satellite and an indication of the transit time of the signalling event transmitted by the reference satellite; and
calculating the location of the receiver in dependence on those comparisons;
the method further comprising determining, for each of the satellites in the constellation, an indication of an error that would be incorporated in the comparisons if that satellite were selected as the reference satellite and selecting the reference satellite in dependence on those indications.

20. A computer-readable medium encoded with instructions, that when executed by an apparatus for determining the location of a receiver in dependence on signalling events transmitted to the receiver by a satellite constellation comprising a reference satellite and one or more other satellites, cause the apparatus to:
for each of the one or more satellites, compare an indication of the transit time of the signalling event transmitted by that satellite and an indication of the transit time of the signalling event transmitted by the reference satellite; and
calculate the location of the receiver in dependence on those comparisons;
the instructions further causing the apparatus to determine, for each of the satellites in the constellation, an indication of an error that would be incorporated in the comparisons if that satellite were selected as the reference satellite and to select the reference satellite in dependence on those indications.
